(19) United States
(12) Patent Application Publication
(10) Pub. No.: US 2020/0355008 A1
(43) Pub. Date: Nov. 12, 2020

(54) ACTUATOR WITH HOLLOW WORM

(71) Applicant: IWIS Antriebssysteme GmbH & Co. KG, 81369 München (DE)

(72) Inventors: PETER KREISFELD, Winkelhaid (DE); JOEL TCHAWEU TCHATCHOUA, Puchheim (DE); FRANK RASCH, Wilnsdorf (DE); ORHAN SAHIN, München (DE); THOMAS WOLF, München (DE); ABHIJIT POTDAR, München (DE); GERHARD HARTINGER, Geretsried (DE)

(73) Assignee: IWIS Antriebssysteme GmbH & Co. KG, 81369 München (DE)

(21) Appl. No.: 16/071,378

(22) PCT Filed: Jan. 20, 2017
(86) PCT No.: PCT/EP2017/051196

§ 371 Date: Jul. 19, 2018

(30) Foreign Application Priority Data
Jan. 20, 2016 (DE) 10 2016 000 566.1

(51) Int. Cl. E05F 15/616; E05F 15/635; F16G 13/20

(52) U.S. Cl. CPC E05F 15/616; E05Y 2201/656; F16G 13/20; E05F 15/635

(57) ABSTRACT

The invention relates to an actuator with an anti-backbend chain, a drive motor, and a worm which can be driven by the drive motor. The anti-backbend chain has alternating inner and outer chain links, and chain pins which connect the links, wherein at least some of the chain pins have laterally protruding engagement regions which engage with the worm in order to drive the anti-backbend chain. Such an actuator is to have a more advantageous design. For this purpose, the worm is designed as a hollow worm, and the engagement regions of the chain pins engage with an inner helical surface of the hollow worm.

The present invention relates to an actuator having an anti-backbend chain, a drive motor, and a worm with a helical groove which can be driven by the drive motor, wherein the anti-backbend chain has alternating inner and outer chain links, and chain pins which connect them, and at least some of the chain pins have engagement regions which project laterally and which engage with the spindle to drive the anti-backbend chain.

EP 1353031 B2 describes an embodiment (FIG. 8) in which the chain is configured with laterally projecting teeth which engage in a spindle driven by a motor. The anti-backbend chain is guided along the spindle and is deflected by 90° in the region between the motor and the spindle, and is guided outwards to actuate an element. The spindle is much shorter than the anti-backbend chain. Power is transmitted laterally onto the chain, such that torques are directed into the chain which must be absorbed by the chain links.

A hand-operated variant of a similar actuator is described in DE 714768. Such actuators serve the purpose of opening and closing windows and doors, by way of example.

A disadvantage of these designs is the drive load on the chain, and the associated wear.

It is therefore the object of the present invention to improve an actuator of the type mentioned above with respect to the transmission of force to the anti-backbend chain.

This object is achieved in a generic actuator by the fact that the worm is designed as a hollow worm, and the engagement regions of the chain pins are in engagement with the internal helical surface of the hollow worm.

Routing the anti-backbend chain through a hollow worm driven by the drive motor can lead to several advantages. By means of a hollow worm, for example, a symmetrical force can be directed into the anti-backbend chain. Furthermore, a hollow worm can have a more stable design with a comparable arrangement position in extension of the motor axis, or parallel and slightly offset thereto, compared to a worm with an external helix. Even if the hollow worm is only in engagement on one side with the anti-backbend chain, the opening of the hollow worm can be additionally used to support the chain. In most cases, higher drive forces can be directed into the anti-backbend chain as a result of the design.

In a particularly advantageous construction, the drive motor is arranged as an extension of the hollow worm—and the motor axis and worm axis are preferably arranged coaxially to each other. If the pushing force is also applied away from the drive motor in extension of the same, then it is not necessary for a deflection to occur in the force-loaded region of the anti-backbend chain. As a result, the non-loaded part of the anti-backbend chain can be deflected accordingly expediently for the purpose of accommodating the same. Overall, this enables a more space-saving construction compared to the prior art.

Preferably, the hollow worm can be designed with multiple threads, and can accordingly have a plurality of internal helical surfaces. This offers the advantage, by way of example, of bringing each of the two sides of the anti-backbend chain into engagement with a different internal helical surface.

In addition, the chain pins of the anti-backbend chain can project alternately on one side and on the other side of the anti-backbend chain, forming corresponding engagement areas. This ensures in a simple way that both sides of the anti-backbend chain come into engagement with the hollow worm, such that a symmetrical application of force can be achieved. In particular, in such an embodiment, there is the possibility that one side of the anti-backbend chain is in engagement with a different internal helical surface than the other side. As a result, faster feed movements per revolution can be realized.

In addition, the engagement means can have elements for reducing friction, in the form of at least one rotatable roller or a sliding shoe which engages in the helical groove of the hollow worm. Sliding shoes may have the shape of a fitted key, or the cross-sectional shape of an ellipse. Also, a height-convex fitted key shape or elliptical shape can be used. All lateral surfaces can be convex in this case. The rollers can be mounted on ball bearings, or can actually be ball bearings themselves. The use of sintered rollers, which may be soaked in a lubricant, is also possible.

In a further embodiment, the engagement means have elements for slip compensation, in the form of a plurality of rotatable rollers arranged next to each other on a projecting chain pin, and/or a conical roller and a helical groove adapted thereto. Due to speed differences over the worm radius, slippage occurs at the contact points between roller and hollow worm. If several shorter rollers are attached to one extended bolt, each roller will have a different speed. Slip is significantly reduced. The conicity of the rollers and of the hollow worm is used to compensate for speed differences.

In a variant, a guide which extends through the hollow worm is included, and this guides the front side and/or the back side of the anti-backbend chain. This prevents the anti-backbend chain, aside from the engagement regions thereof, from corning into contact with the hollow worm, so that it only moves linearly through the hollow worm.

A particularly slim design results according to a further embodiment if the drive motor has a hollow shaft through which the anti-backbend chain is guided. Such a variant opens up the possibility of applying a pushing force along the motor axis in both directions. This depends largely on the design of the anti-backbend chain. In addition, a compact design is achieved due to the fact that a certain chain length is situated in the region of the drive motor. In extreme cases, the hollow worm and hollow shaft could also be combined into a single functional element.

Furthermore, a guide which extends through the hollow shaft can be present in this case, and can guide the front side and/or the back side of the anti-backbend chain. Such a guide can also be constructed as a single piece with the guide through the hollow worm. The rail may also have rollers or wheels to reduce friction, or can be replaced by rollers or wheels.

Most of the commonly available electrically-driven drive motors have too high a rotation speed for many applications. As such, it is appropriate for the drive motor to have a transmission, and for a transmission shaft to drive the hollow worm. Translations of 4:1 or 6:1 can be used in this case. Due to such a reduction, the torques to be transmitted can be increased.

In a further variant, the hollow worm has an engagement region in which an engagement means driven by the transmission shaft engages to drive the hollow shaft. In this case, an external toothing on the hollow worm, and a gear or a toothing on the transmission shaft, can be contemplated, by way of example, thereby achieving a further reduction as well, for example.

In a further embodiment, the anti-backbend chain may be deflected in a space between the hollow worm and the drive motor, and guided laterally out of the space. Such a variant can serve the purpose of applying a pushing force transversely to the motor axis. This results in an advantageous adaptability to different actuating situations. If the section of the anti-backbend chain guided laterally out of the space is the non-loaded section of the anti-backbend chain, this results in a lower-wear design compared to a pushing direction transverse to the motor axis.

Preferably, the anti-backbend chain may be a bush chain or roller chain, and can have a width which is greater than the inside diameter of the hollow worm and less than the outside diameter of the at least one internal helical surface of the hollow worm. Conveniently, the width extends almost to the outside diameter of the at least one internal helical surface in order to achieve the greatest possible engagement. A bush chain or roller chain is made up of standard components, and can also be very easily configured with stiffening elements. There is a variety of embodiments which can be generally used as alternatives. In the case of a roller chain, the rollers can additionally be used for a low-friction guidance of the anti-backbend chain. A correspondingly adapted guidance is beneficial in this case.

In order to achieve the best possible load distribution, the hollow worm can be mounted by its outer circumference. Accordingly, bearings with a large diameter can be used, such that correspondingly large forces can be transmitted.

Of particular advantage is a variant in which the pushing direction of the anti-backbend chain points away from the drive motor in the direction of, or parallel to, the motor axis. This also opens up the possibility of designing the actuator as a modular unit which has a housing with an attachment means and an opening for the extension and retraction of the chain. If the attachment device and the opening are included on an end face of the housing which faces the opposite direction, then the actuator can be used as an alternative to a hydraulic- or pneumatic cylinder, such that an electric drive is furnished as an alternative. In order to prevent the entry of dirt, the guidance of the chain out of the housing can be equipped with a specially shaped brush. This brush could also relubricate the chain, including the friction reducing elements—especially the sliding shoes.

Furthermore, position elements can be attached to the anti-backbend chain, which can be detected by means of one or more sensors. Preferably, the position elements can be easily mounted and removed—for example, by clipping into the anti-backbend chain. Due to the fact that the anti-backbend chain does not require a sprocket for the drive thereof, the position element can be inserted in a gap of the chain (e.g., between two sleeves or rollers). Conveniently, the position element may be a permanent magnet with a holder, and the sensor may be a magnetic sensor, in particular a Hall sensor. Due to the easy displaceability of the position element, the stroke or the stroke limitation can be easily adjusted and/or set. The sensor then ensures a corresponding control of the drive motor. The drive motor is switched off, for example. An electronic control unit can also be installed in the housing, such that the actuator is fully functional and only needs to be supplied with power, and is activated by control commands. The base plate can also serve to dissipate heat—for example, from the power semiconductors.

Clip-in magnetic markings (position elements) can be used as reference points, by means of which the electronic control unit may divide the total travel path into any number of partial paths. In the following, embodiments of the present invention will be explained in more detail with reference to drawings, wherein:

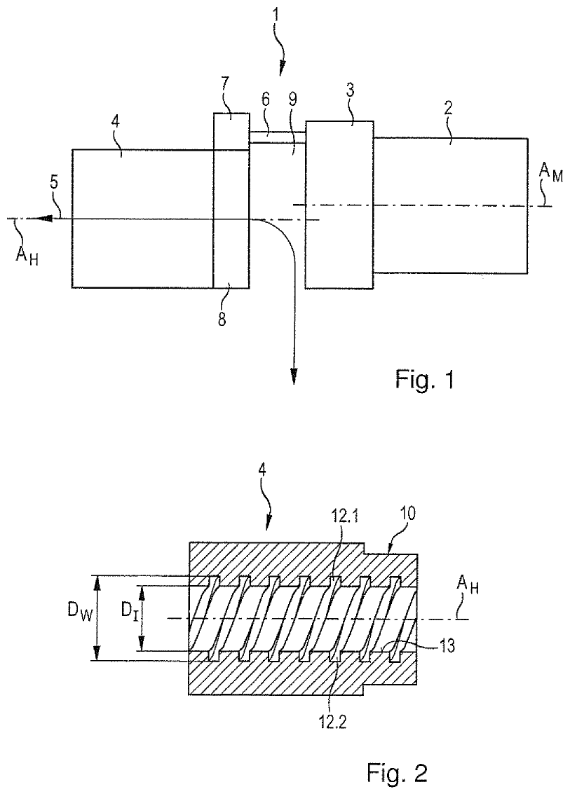

FIG. 1: shows a schematic illustration of a first embodiment of an actuator according to the invention,

FIG. 2: shows a cross-sectional view of an embodiment of a hollow worm,

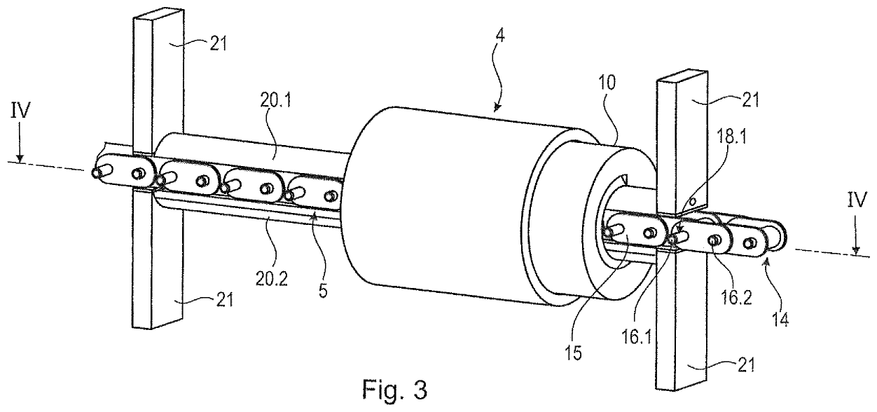

FIG. 3: shows a perspective view of a guided anti-backbend chain and a hollow worm,

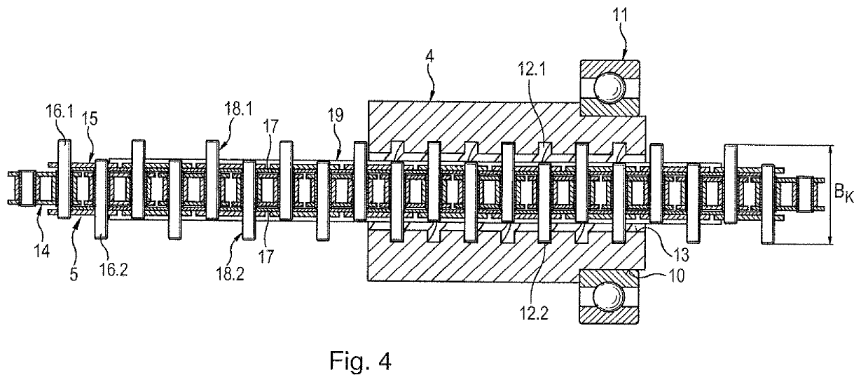

FIG. 4: shows a full section of the arrangement of FIG. 3, cut along the line IV.-IV.

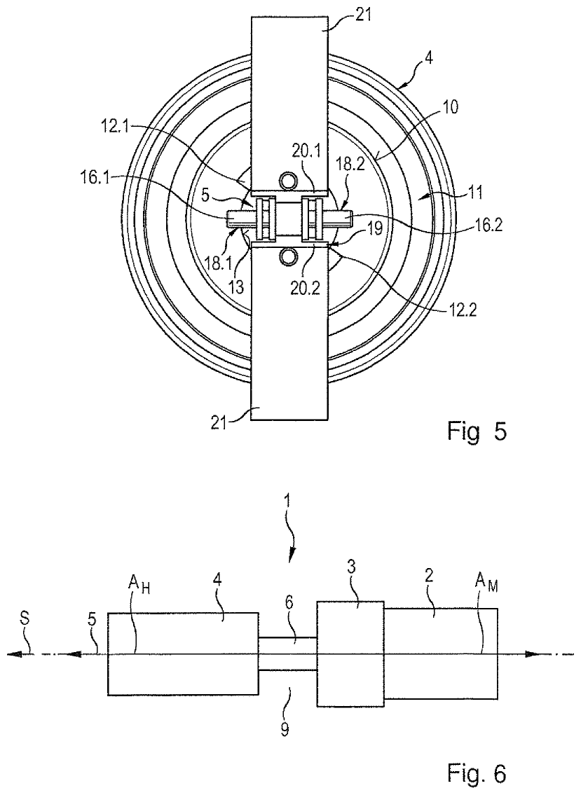

FIG. 5: shows a front view of the arrangement of FIG. 3, and

FIG. 6: shows a schematic view of a second embodiment of an actuator according to the invention.

The actuator 1 shown schematically in FIG. 1 comprises, as essential components, an electric drive motor 2 with a transmission 3, a hollow worm 4 driven by the drive motor 2, and an anti-backbend chain 5. The transmission shaft 6 with a toothed wheel 7 arranged thereon in a torque-proof manner, which engages with an outer toothing 8 of the hollow shaft 4, is also included in the drawing. The anti-backbend chain 5 is deflected in the space 9 between the drive motor 2 and the hollow worm 4. The deflection can be guided or unguided. If the section of the anti-backbend chain 5 which is guided laterally out of the space 9 will apply the pushing force transverse to the motor axis A_{M}, a guide for the anti-backbend chain 5 must be included which accordingly absorbs the pushing force. For most purposes, it can be contemplated that the pushing force is applied away from the drive motor 2 along the hollow worm axis A_{R}, because then the deflection can take place in the space 9 substantially in the force-free section. The force-free section of the anti-backbend chain 5 can then be deflected further in a suitable manner to produce a chain depot—for example, along the drive motor 2 with the transmission 3.

The illustrated embodiment has the advantage that the outer toothing 8 results in a further reduction together with the toothed wheel 7, which is why the transmission 3 can have a simplified design. The motor shaft engages accordingly with the transmission 3, such that the transmission shaft 6 is driven.

The anti-backbend chain 5 is preferably a bush or roller chain which engages with the internal contour of the hollow worm and is moved by the same in the longitudinal direction.

An embodiment of a hollow worm 4 will now be explained in more detail with reference to FIG. 2. Such a hollow worm 4 can also be used in an embodiment according to FIG. 1. The hollow worm 4 has a cylindrical shoulder 10 on one end, which can either be used for the arrangement of a hardened toothed ring providing the outer toothing 8 (see FIG. 1) or for the arrangement of a bearing 11 (see FIG. 4, for example). The hollow worm 4 is designed with multiple threads, and has two internal helical surfaces 12.1 and 12.2 with the same slope. Each of the grooves which form the internal helical surfaces 12.1 or 12.2 is rectangular in cross-section. The internal helical surfaces 12.1, 12.2 are incorporated in the cylindrical opening 3 of the hollow worm 4. The internal helical surfaces 12.1 and 12.2 are in engagement with suitable engaging means of the anti-backbend chain 5. When the worm 4 turns, this leads to a longitudinal movement of the anti-backbend chain 5 guided through the cylindrical opening 13.

In the following, the interaction of the anti-backbend chain 5 with the hollow worm 4 will be explained in more detail with reference to an embodiment and to FIGS. 3-5.

The illustrated anti-backbend chain 5 is a roller chain with alternating inner chain links 14 and outer chain links 15. Each inner chain link 14 comprises, in a known manner, two mutually parallel inner plates which are interconnected by means of two mutually spaced sleeves. Rotatable rollers are arranged on the sleeves. Each outer chain link 15 comprises two mutually parallel outer plates which are connected to each other by means of two pivot pins 16.1 and 16.2. The pivot pins 16.1 and 16.2 are each inserted through the associated sleeves of the adjacent inner chain links 14 to form a chain link. Between the inner chain links 14 and the outer chain links 15, stiffening tabs are arranged. These allow a pivoting of the anti-backbend chain 5 in at least one direction, but also allow the transmission of a pushing force by means of the anti-backbend chain 5. The chain pins 16.1 and 16.2 have an extended construction, and project laterally on alternating, different sides, forming corresponding engagement regions 18.1 and 18.2. These come into engagement with the respective, internal helical surfaces 12.1 and 12.2 of the hollow worm 4. The total width B_{K} of the anti-backbend chain 5 is greater than the inner diameter D_{I} of the cylindrical opening 13, and slightly smaller than the outer diameter D_{W} of the internal helical surfaces 12.1 and 12.2. The use of a multi-thread hollow worm 4 leads to a large feed movement of the anti-backbend chain 5 with an increased possibility of engagement provided by the engagement regions 18.1 and 18.2 of the chain pins 16.1 and 16.2. Every two chain pins 16.1 or 16.2 project on the same side of the anti-backbend chain 5 to form one of the engagement regions 18.1 and 18.2. In addition to the anti-backbend chain 5, a guide 19 which is composed of two guide rails 20.1 and 20.2 is also inserted through the hollow worm 4. The guide rails 20.1 and 20.2 are adapted, along their spines, to the circular shape of the cylindrical opening 13, such that they have a corresponding spacing from the same. On their inwardly facing surfaces, the guide rails 20.1, 20.2 are designed in such a manner that the rollers of the anti-backbend chain 5 roll along the same. The end faces of the guide rails 20.1 and 20.2 are bolted to corresponding attachment strips 21. The length of the guide 19 can be selected according to the concept of the actuator 1, Appropriately adapted guides can be used depending on whether the anti-backbend chain 5 is merely guided in a straight line or—for example, according to the embodiment in FIG. 1—is deflected laterally.

In the following, the mode of action and operation of the actuator 1 according to the invention will be explained in more detail. The use of a rotating hollow worm 4 driven by the drive motor 2 leads to a substantially symmetrical force application into the anti-backbend chain 5, since the same engages on both sides thereof with the drive element—the hollow worm 4. Axial forces are very efficiently directed into the anti-backbend chain 5 as a result. The various forms of drive by means of a drive motor 2 and an associated transmission 3 open up numerous possibilities for the construction, such that an adaptation to the different installation conditions is possible. To achieve the slimmest possible design of actuators 1, however, it is preferred that the hollow worm 4 and the drive motor 2 with the transmission 3 are arranged substantially one behind the other, as is the case in FIG. 1. There can also be a slight offset of the sleeve axis A_{H} and the motor axis A_{M}. In one embodiment according to FIG. 1, the pushing force can be applied by the drive motor 2 both in the longitudinal direction (that is, substantially parallel to the motor axis A_{M}), and transversely—preferably perpendicular to the motor axis A_{M}. This depends largely on the design of the anti-backbend chain 5 and the guidance. However, the pushing force is preferably applied substantially in extension and/or parallel to the motor axis A_{M}, such that the load-free section of the anti-backbend chain 5 can also be deflected several times to accommodate the anti-backbend chain 5 in a chain depot (not shown).

In the following, a further embodiment of an actuator 1 according to the invention will be explained in more detail with reference to FIG. 6.

The essential difference in this embodiment is that the axis A_{H} of the hollow worm 4 is substantially coaxial with the motor axis A_{M} of the drive motor 2. For this purpose, the motor shaft of the drive motor 2 is designed as a hollow shaft. Also, the transmission 3 is designed in such a manner that the anti-backbend chain 5 can be guided centrally through the transmission 3. In this case, a central, hollow transmission shaft can be contemplated. The driving transmission shaft 6 is also designed as a hollow shaft, and is coupled to the hollow worm 4. In such an embodiment, it is not absolutely necessary to deflect the anti-backbend chain 5. An actuating length of anti-backbend chain 5 is essentially automatically available which substantially corresponds to the length of the drive motor 2 including the length of the transmission 3 with the transmission shaft 6. Nevertheless, a chain depot in which a deflection of the anti-backbend chain 5 can occur can also be behind the drive motor 2. Also in this embodiment, it is possible that the anti-backbend chain 5 transmits a pushing force in both directions. Preferably, however, the pushing force is applied away from the drive motor 2—because the greatest actuation length is usually available in this direction (see pushing direction S in FIG. 6). A suitable guide 19 can then extend through the transmission 3 and the drive motor 2, as well as through the hollow worm 4.

The actuator 1 according to the invention is preferably driven electrically and can be a substitute for the concept of hydraulic- or pneumatic cylinders. For this reason, slim designs with a pushing force application in the longitudinal direction along the axis A_{H} of the hollow worm 4 and the motor axis A_{M} of the drive motor 2 are preferred. The drive motor 2, together with the transmission 3 and the hollow worm 4, can be accommodated in a shared housing, on the front end of which the actuating region of the anti-backbend chain 5 emerges. Also, a chain depot can be accommodated inside this housing, such that a structural unit results which is similar to a hydraulic cylinder or a pneumatic cylinder. The housing can be equipped on an end opposite the actuating region of the anti-backbend chain 5 with a corresponding attachment device—such as a joint head with ball joint. By means of the actuator 1 described here, pushing forces can be applied in the manner required for, by way of example, opening windows or doors, etc. Other applications—for example, in the context of conveying and transport—are also possible.

### LIST OF REFERENCE NUMBERS

1 actuator
2 drive motor
3 transmission
4 hollow worm
5 anti-backbend chain
6 transmission shaft
7 toothed wheel
8 outer toothing
9 space
10 shoulder
11 bearing
12.1, 12.2 inner helical surfaces
13 cylindrical opening
14 inner chain link
15 outer chain link
16.1, 16.2 chain pins
17 stiffening plates
18.1, 18.2 engagement region
19 guide
20.1, 20.2 guide rail
21 attachment strip
A_{H} hollow worm axis
M_{A} motor axis
D_{W} internal: helical surface diameter
D_{I} internal opening diameter
S pushing direction

1.-15. (canceled)

16. An actuator, comprising:
a drive motor;
a worm having a helical groove and driveable by the drive motor; and
an anti-backbend chain including alternating inner and outer chain links and chain pins which connect the inner and outer chain links, at least some of the chain pins having engagement regions which project laterally and engage with the worm to drive the anti-backbend chain,
wherein the worm is designed as a hollow worm, said engagement regions of the chain pins being in engagement with an internal helical surface of the hollow worm.

17. The actuator of claim 16, wherein the drive motor is arranged as an extension of the hollow worm.

18. The actuator of claim 16, wherein the drive motor defines a motor axis, said motor axis and a hollow worm axis being arranged coaxially to each other.

19. The actuator of claim 16, wherein the hollow worm is designed with multiple threads and resultant plural internal helical surfaces.

20. The actuator of claim 16, wherein the chain pins of the anti-backbend chain project alternately on one side and on another side of the anti-backbend chain, forming corresponding ones of the engagement regions.

21. The actuator of claim 20, wherein the engagement regions of the chain pins on one side of the anti-backbend chain engage in a different internal helical surface than the engagement regions of the chain pins on the other side of the anti-backbend chain.

22. The actuator of claim 16, further comprising a guide extending through the hollow worm and configured to guide a front side and/or a back side of the anti-backbend chain.

23. The actuator of claim 16, wherein the drive motor has a hollow shaft through which the anti-backbend chain is guided.

24. The actuator of claim 23, further comprising a guide extending through the hollow shaft of the drive motor and configured to guide a front side and/or a back side of the anti-backbend chain.

25. The actuator of claim 16, wherein the drive motor has a transmission and a transmission shaft which drives the hollow worm.

26. The actuator of claim 25, wherein the hollow worm includes an engagement region in which an engagement means driven by the transmission shaft engages to drive the hollow worm.

27. The actuator of claim 16, wherein the anti-backbend chain is deflected in a space between the hollow worm and the drive motor, and guided laterally out of the space.

28. The actuator of claim 27, wherein the anti-backbend chain has a section which is guided laterally out of the space and represents a non-loaded section of the anti-backbend chain.

29. The actuator of claim 16, wherein the anti-backbend chain is a bush chain or roller chain having a width which is greater than an inside diameter of the hollow worm, and less than an outside diameter of the internal helical surface of the hollow worm.

30. The actuator of claim 16, wherein the hollow worm is mounted by its outer circumference.

31. The actuator of claim 16, wherein a pushing direction of the anti-backbend chain points away from the drive motor in a direction of, or parallel to, the motor axis
